(19) United States
(12) Patent Application Publication
(10) Pub. No.: US 2008/0001967 A1
(43) Pub. Date: Jan. 3, 2008

(54) Display bandwidth reduction apparatus, system, and method

(76) Inventors: Srikanth Rengarajan, Austin, TX (US); Moinul H. Khan, Austin, TX (US)

Correspondence Address: KACVINSKY LLC;C/O INTELLEVATE, P.O. BOX 52050, MINNEAPOLIS, MN, 55402, US

(21) Appl. No.: 11/479,238

(22) Filed: Jun. 30, 2006

(51) Int. Cl. G09G 5/00

(52) U.S. Cl. 345/629

(57) ABSTRACT

A system, apparatus, method, and article to reduce display bandwidth are described. The apparatus may include a display controller to identify an opaque region in windows defining an output image. The display controller determines an overlay order for any overlapping portions of the windows. A higher order window overlays a lower order window. The display controller fetches data defining the opaque region only from an uppermost overlay window prior to displaying the output image.

### BACKGROUND

The usage model for display devices in most handheld computing/communication devices typically involves support for multiple windows, with each window often representing a different application. As used in this context, a window may be defined as a visual area, usually rectangular in shape, containing some kind of user interface, displaying the output of, and allowing input for one of a number of simultaneously running computer processes. Windows are primarily associated with graphical displays, where they can be manipulated with a pointer. An output image in the visual area of the final display may be determined by the order of superposition of the windows, which is typically hard-coded. Display controllers are used to fetch the information or data defining the windows, determining an order of superposition for the multiple windows that are applicable to the output image. Conventional display controllers generally fetch all the overlays windows that are applicable to an output image. Depending on user settings on transparency (or opaqueness), the overlay data is merged together to present a composite output image. If a given window is deemed opaque, however, then all the data in the windows whose positional order is lower (higher order=closer to viewer) than the opaque window do not form a part of the final image and their data is discarded. The process of fetching all windows that are applicable to the output image and then discarding those that ultimately do not form a part of the final output image is wasteful of the total bandwidth of the display device. Therefore, there is a need for apparatuses, systems, and methods to reduce the total bandwidth required by the display device in providing an output image that includes superpositioned windows.

### BRIEF DESCRIPTION OF THE DRAWINGS

FIG. 1 illustrates one embodiment of a device.

FIG. 2 illustrates a diagram of one embodiment of a range buffer scheme for a display.

FIG. 3 illustrates a diagram of one embodiment of a field configuration for a range buffer.

FIG. 4 illustrates a block diagram of one embodiment of a display controller.

FIG. 5 illustrates a graph that is representative of the peak bandwidth reduction that may be achieved utilizing the various embodiments of the display controller and range buffer described in FIGS. 1-4.

FIG. 6 illustrates one embodiment of a logic flow.

### DETAILED DESCRIPTION

In one embodiment, a display controller may comprise logic to identify an opaque region in windows defining an output image. The display controller determines an overlay order for any overlapping portions of the windows. A higher order window overlays a lower order window. The display controller fetches data defining the opaque region only from an uppermost overlay window prior to displaying the output image.

In various other embodiments, the display controller may comprise logic to define multiple ranges of the output image. The multiple ranges define vertical portions of the windows. The display controller defines multiple sub-ranges within the multiple ranges. The multiple sub-ranges define horizontal portions of the windows. The display controller determines a transparency level for each of the windows in the multiple sub-ranges. The display controller retrieves only a single blended transparency level for any of the overlapping portions of the windows in any one of the multiple sub-ranges.

In various other embodiments, the display controller may comprise logic to identify a sub-range within a range by a first starting X-value and the transparency level for all windows within the sub-range. The sub-range defines the blended transparency level for the overlapping in the sub-range. The display controller may comprise logic to identify the end of any one of the sub-ranges by a single ending X-value, wherein beyond the ending X-value the sub-range does not contain a window. The display controller may comprise logic to define a range buffer comprising multiple sub-range fields, wherein the sub-range fields comprise first and second fields. The first field is to store a starting X-value for a corresponding sub-range of the display and the sub-range fields. The second field is to store the blended transparency level for each of the windows in the sub-range.

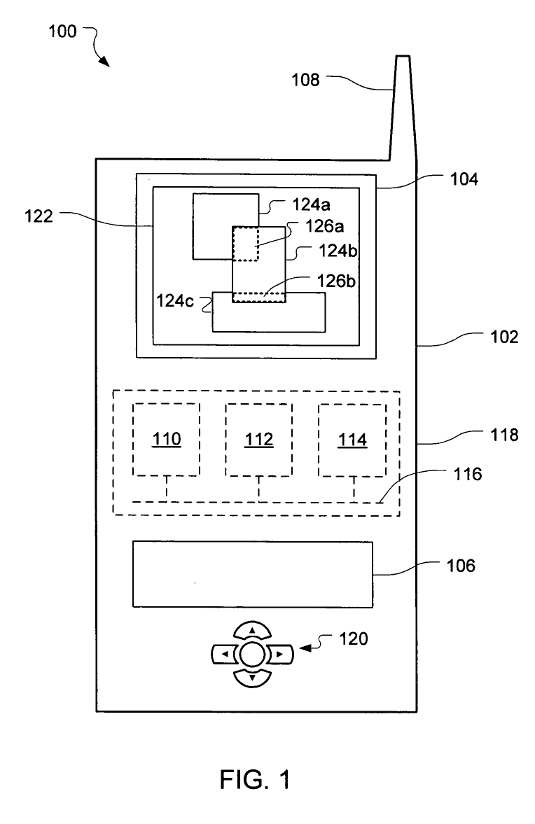

FIG. 1 illustrates one embodiment of a device 100. In one embodiment, for example, the device 100 may comprise a communication system. In various embodiments, the device 100 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, the device 100 may be implemented as part of a wired communication system, a wireless communication system, or a combination of both. In one embodiment, for example, the device 100 may be implemented as a mobile computing device having wireless capabilities. A mobile computing device may refer to any device having a processing system and a mobile power source or supply, such as one or more batteries, for example. Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 1, the device 100 may comprise a housing 102, a display 104, an input/output (I/O) device 106, an antenna 108, a processor 110, memory 112, and a display controller 114. The processor 110, memory 112, and display controller 114 may be interconnect via system bus 116 and may form a portion of a processing system 118. A range buffer (described hereinbelow) may be implemented in the memory 112. The device 100 also may comprise a five-way navigation button 120. The display 104 may comprise any suitable display unit for displaying information appropriate for a mobile computing device. The I/O device 106 may comprise a suitable keyboard, a microphone, and/or a speaker, for example. The I/O device 106 may comprise any suitable I/O device for entering information into a mobile computing device. Examples for the I/O device 106 may include an alphanumeric keyboard, a numeric keypad, a touch pad, input keys, buttons, switches, rocker switches, voice recognition device and software, and so forth. Information also may be entered into the device 100 by way of microphone. Such information may be digitized by a voice recognition device. The embodiments are not limited in this context.

In one embodiment, a usage model for the display 104 that supports an output image 122 comprising multiple window planes 124a, b, N, where N may be any number, may be implemented with the display controller 114. At least two or more of the multiple window planes 124a, b, N may overlap in some region. Windows planes that overlap may be referred to herein as overlay windows and the regions of the two or more window planes that overlap may be referred to as overlay regions. Each of the window planes 124a-N may represent a different application, for example, from a number of simultaneously running computer implemented processes. The output image 122 on the display 104 may be determined by the order of superposition of the window planes 124a-N. In one implementation, the display controller 114 determines the order of superposition of the window planes 124a-N to reduce the total bandwidth required by the display controller 114 to display the output image 122. In the embodiment illustrated in FIG. 1, the window plane 124b overlays the window plane 124a and defines a first overlay region 126a identified in darkened broken line. Further, the window plane 124b overlays the window plane 124c and defines a second overlay region 126b identified in darkened broken line. Multiple overlay regions may be defined for a given output image comprising multiple window planes 124a-N.

In one embodiment, the display controller 114 may be implemented as logic (e.g., software, hardware, or a combination of software and hardware). To simplify the description the logic may be presented in terms of pseudo-code and a reference implementation thereof throughout this description. The display controller 114 and the logic may identify the presence of opaque windows among the window planes 124a-N or regions in the output image 122 of the display 104 to avoid wasteful fetching of data from all lower-order windows to be displayed. The identification of opaque windows or opaque regions in overlapping windows may be referred to as determining window “occlusion.” In other embodiments, the display controller 114 and the logic may identify the presence of transparent windows among the window planes 124a-N or regions in the output image 122 of the display 104 to avoid wasteful fetching of data to be displayed. Thus, one embodiment of the display controller 114 may be implemented to avoid fetching all the windows that are applicable to the output image 122 as may be currently implemented in conventional display controllers. Depending on the user selected window transparency settings, the overlay data may be merged together or blended to present a composite output image 122 on the display 104. If a given window plane 124a-N is deemed opaque, however, then all data in the window planes 124a-N whose positional order is lower (higher order=closer to viewer) than the opaque window do not form a part of the output image 122 and their data may be discarded.

This provides a savings in bandwidth because only the data required to present the composite output image 122 is retrieved and not all data associated with all the windows to be displayed. Various embodiments comprising a micro-architectural solution are described herein for leveraging the opacity characteristics of overlaid window planes 124a-N used by the display controller 114. A standard first-in-first-out (FIFO) registers and comparators and some software overhead may be utilized to implement the various embodiments, although they are not limited in this context. Software intervention may be limited to a period where there is frame configuration update activity, for example. The various embodiments described herein may be scalable across the various number of window planes 124a-N and may be independent of alpha encoding methodologies where alpha stands for the transparency or opaqueness level of a particular window plane 124a-N. Depending on the particular implementation the alphas associated with the window planes 124a-N may take on values from 0 to 1 (or 0% to 100%) where a value of 0 may represent total transparency/opaqueness and a value of 1 may represent total opaqueness/transparency and fractional values between 0 and 1 may represent variable levels of transparency/opaqueness or opaqueness/transparency, for example.

Thus, the various embodiments described herein may provide increased performance through lower bandwidth requirements. Normal usage models of display imagery have significant opacity amongst the overlays that can be leveraged to reduce system bandwidth bottlenecks and thereby also reduce system power consumption. Increasing display resolutions and lowering power consumption may be particularly valuable for mobile computing devices such as the device 100.

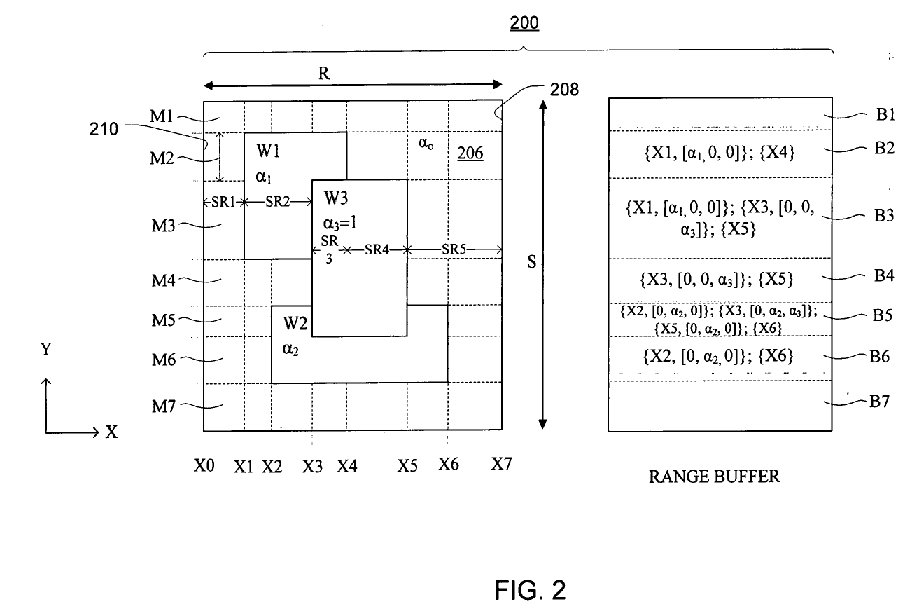

FIG. 2 illustrates a diagram 200 of one embodiment of a range buffer 202 scheme for a display 204. The display 204 may be one embodiment of the display 104 shown in FIG. 1. The display 204 has a size of R×S pixels, where R represents the width in number of pixels and S represents the height in number of pixels. The display may comprise an alpha (αₓ) precision of p-bits. For a given display, the range buffer 202 may require a memory of a predetermined size in terms of bits of storage. For example, for the display 204 having a size of R×S pixels, p-bits of precision, and N window planes (e.g., the number of window planes corresponding to the windows 124a-N as shown in FIG. 1), the size of the range buffer 202 may be defined in memory as:

S(2N+1)(Log₂ R+pN) bits of storage (1)

Accordingly, the embodiments described herein may be implemented in a logic such as an algorithm, computer implemented method, hardware software, or a combination of hardware/software that may be represented using pseudo-code, and a reference implementation thereof, to identify the presence of opaque windows (“occlusion”) or regions and thereby avoid the wasteful fetching of data from all lower-order windows. To leverage from the occlusion detection, the following scheme of window planes W_{1-N} representation may presented. In one embodiment, the window planes W_{1-N} may be the windows 124a-N shown in FIG. 1, for example. Given N window planes, Wᵢ: i=1, 2, . . . N, the order of placement of each window plane W_{1-N} may be given by Oᵢ: i=1, 2, . . . N. In either case, i=1 is the deepest window plane (e.g., W₁ is the deepest window plane) and i=N is the uppermost plane of the window (e.g., W_{N} is the uppermost window plane).

The transparency level of each window plane W_{1-N} may be represented by αᵢ, where α=1 indicates an opaque window, α=0 indicates full transparency, and values therebetween represent variable levels of opaqueness/transparency. From normalization considerations:

$${\sum }_{i = 1}^{N} {α}_{i} = 1 \qquad ( 2 )$$

The logic or computer implemented method may be implemented as a recursive fetch starting with the highest order window as follows:

αₜₒₜ=0;

For i=N to 1

While ((αₜₒₜ≠1) & (αᵢ≠0)) FETCH(Wᵢ);

αₜₒₜ=αₜₒₜ+αᵢ;

End for.

Depending on the size and location of the occluded widows, the reduction in bandwidth needed to service the display 104 may range from 0% to 100*(N−1)/N %. In one embodiment the above logic may be implemented using a software assisted range buffer. The pixels for each window W_{1-N} may be fetched on a per-line basis. For each line, software may encode the ranges of pixels for which the blending configuration is the same. A configuration may be defined as the complete set of windows {Wᵢ} i=1 . . . k (k<=N), that are needed to compute the output image pixel for that range. For a display size of R×S pixels, with an alpha precision of p-bits, the range buffer 202 would need a maximum of S(2N+1)(Log₂ R+pN) bits of storage.

In the embodiment illustrated in FIG. 2, the display 204 has three active windows W₁, W₂, and W₃ on top of a base plane 206. The display 204 may include up N windows (e.g., 124a-N or W_{1-N}), where N may be any number. A default alpha α value for the base plane 206 may be denoted as α₀ and the alphas for the windows W₁, W₂, and W₃ may be denoted as α₁, α₂, and α₃, respectively. Thus for N windows W_{1-N} there may be defined up to N corresponding alpha α_{1-N} values. The value of alpha α_{1-N} represents a degree of transparency or opaqueness ranging from 0-1 (or 0-100%). For example, if values of α_{1-N} represent degrees of transparency, then a value of α_{1-N}=0 corresponds to a non-transparent (i.e., fully opaque) window W_{1-N}, a value of α_{1-N}=1 corresponds to a fully transparent window W_{1-N}, and values of alpha 0<α_{1-N}<1 correspond to varying degrees of transparency. Alternatively, if values of α_{1-N} represent degrees of opaqueness, then a value of α_{1-N}=0 corresponds to a non-opaque (i.e., fully transparent) window W_{1-N}, a value of α_{1-N}=1 corresponds to a fully opaque window W_{1-N}, and values of alpha 0<α_{1-N}<1 correspond to varying degrees of opaqueness.

In the range buffer 202, the location of each window W₁₋₃ may be given in terms of starting and ending co-ordinates in the {X, Y} plane, where X represents the horizontal axis and Y represents the vertical axis. Based on the X, Y co-ordinates, the display 204 may be divided into multiple ranges M₁ to Mⱼ, where ‘j’ may be any number. Each range M₁₋ⱼ spans the entire horizontal width of the display 204 screen (R pixels horizontally) and the height of each range M₁₋ⱼ may vary from a single pixel to S pixels in the vertical direction. Depending on the co-location of the windows W₁₋₃ and their relative order of superposition, each range M₁₋ⱼ may be divided into one or more sub-ranges SR₁₋ₖ, where ‘k’ may be any number, characterized by the corresponding alpha α_{1-N} blending configuration.

In the embodiment illustrated in FIG. 2, for example, the display 204 is divided into seven ranges M₁₋₇ across the horizontal (X) direction. For each of the seven ranges M₁₋₇, there may be one or more sub-ranges SR₁₋ₖ. For example, for the M₃ range there are five sub-ranges SR₁₋₅ defined in the horizontal (X) direction. The order and composition of the windows W₁₋₃ is the same for all the pixels in any given sub range (SR₁₋ₖ).

In the range buffer 202, each sub-range SR₁₋ₖ within a range Mⱼ may be uniquely identified by its starting X-value. In the embodiment illustrated in FIG. 2, each sub-range SR₁₋₅ within the M₃ range has a starting and ending X value. For example, for the first sub-range SR₁₋₅ the starting and ending X values are X0 and X1, respectively. For the second sub-range SR₂ the starting and ending X values are X1 and X3, respectively. For the third sub-range SR₃ the starting and ending X values are X3 and X4, respectively. For the fourth sub-range SR₄ the starting and ending X values are X4 and X5, respectively. And for the fifth sub-range SR₅ the starting and ending X values are X5 and X7, respectively. The respective ending X-values for the sub-ranges SR₁₋₅ X1, X3, X5, and X7 may not be stored in the range buffer 202 because they coincide with the start of the next sub-range.

As shown in FIG. 2, the Y-coordinates may be absorbed into the M₁₋ⱼ range information. Associated with each sub-range SR₁₋ₖ are the respective combined alpha values (αₙ′) for all the windows W_{1-N} displayed on the display 204 in that sub-range SR₁₋ₖ. Non-zero values of alpha may be present only for those windows that contribute to the image pixel in that sub-range SR₁₋ₖ as follows:

For (Wₙ AND Mₙ) αₙ′=αₙ

Else αₙ′=0.

### In other words, if a window W_{1-N} does not occupy a range M₁₋ⱼ, the alpha αₙ′ value for that range M₁₋ⱼ is equal to 0.

Thus, the coverage by the windows W_{i-N} may be defined by an alpha N-tet {[α₁, α₂, α₃ . . . α_{N}]} which defines the amount that each alpha α_{1-N} contributes to the image pixel in that range M₁₋ⱼ. The alpha N-tet {[α₁, α₂, α₃ . . . α_{N}]} for a sub-range SR₁₋ₖ may be stored in a corresponding storage range B₁₋ⱼ in the range buffer 202. As previously stated, nothing may be stored in the range buffer 202 storage range B₁₋ⱼ for the base plane alpha α₀. Thus, for each storage buffer range B₁₋ⱼ corresponding to the display range M₁₋ⱼ the alpha N-tet {[α₁, α₂, α₃ . . . α_{N}]} defines the relative contribution of each alpha α₁, α₂, α₃ . . . α_{N} corresponding to the windows W_{1-N} in that range M₁₋ⱼ. Accordingly, in the example embodiment illustrated in FIG. 2, an alpha triplet {[α₁, α₂, α₃]} is stored for each sub-range SR₁₋ₖ occupied by three windows W₁₋₃ in each range M₁₋₇. The range buffer 202 organization may be simplified and the storage requirements minimized in accordance with a rule where nothing is stored for the base plane alpha α₀ and only relative changes in the alpha contributions are stored for each sub-range S₁₋ₖ. Accordingly, for a given range M₁₋ⱼ and sub-range SR₁₋ₖ the alpha triplet {[0, 0, 0]} would indicate that there is no coverage by any of the windows W₁₋₃ for that sub-range SR₁₋ₖ. And the alpha triplets {[1, 0, 0]}, {[0, 1, 0]}, and {[0, 0, 1]} would indicate that there is 100% coverage (e.g., opaqueness, occlusion) by the respective windows W₁, W₂, and W₃, and so forth.

As previously stated, the alphas also may take on values between 0 and 1. Therefore, for a given range M₁₋ⱼ and sub-range SR₁₋ₖ the alpha triplet {[0.85, 0.10, 0.5]} indicates that there is 85% coverage by the window W₁ for that sub-range SR₁₋ₖ, 10% coverage by window W₂, and 5% coverage by window W₃, and so forth. In the range buffer 202, the beginning of a range M₁₋ⱼ may be specified by a single X-coordinate value of the first window W_{1-N} prior to which the ranges M₁₋ⱼ are presumed to be absent of any windows W_{1-N}. The end of range M₁₋ⱼ may be specified by a single X-coordinate value beyond which the range M₁₋ⱼ is presumed to be absent of any windows W_{1-N}. If one or more windows W_{1-N} are coincident with an edge 208, 210 of the display 204, then the ending X-coordinate would be same as the value R or the number of pixel lines across the display 204.

With reference to the embodiment illustrated in FIG. 2, this may be illustrated by way of example. In one embodiment, the range buffer 202 may be implemented as a look-up table. The lines in the range buffer 202 ranges B₁₋₇ correspond to the lines in the display ranges M₁₋₇. For each buffer range B₁₋₇, the range buffer 202 stores the alpha triplets {[α₁, α₂, α₃]} that define the transparency (or opaqueness) level of each window W_{1-N} occupying a corresponding display range M₁₋₇. Accordingly, in the M1 display range, there may be a corresponding B₁ buffer range defined in the range buffer 202 memory. The M₁ display range does not contain any sub-ranges (e.g., does not contain any portion of a window W₁₋₃) for entire M₁ display range R (X0-X7). Accordingly, the range buffer 202 does not store any alpha α values in the B₁ buffer range because there are no windows W_{1-N} in the M₁ display range other than the background panel 206 defined by α₀. This may be interpreted by the display controller 114 as {X0, [0, 0, 0]}; X7}. Hereinafter, the sub-ranges SR₁₋ₖ will be denoted using the following convention (X_{beginning}−X_{ending}), where X_{beginning} is the beginning X-coordinate of the sub-range and X_{ending} is the ending X-coordinate of the sub-range. Thus a sub-range from X1 to X5 is denoted herein as (X1-X5).

In the M₂ display range, the display 204 contains three sub-ranges. A corresponding B₂ buffer range may be defined in the range buffer 202 memory. The first sub-range (X0-X1) contains only the base pane alpha α₀ and there is no corresponding alpha triplet {[α₁, α₂, α₃]} stored in the range buffer 202. This may be interpreted by the display buffer as {X0, [0, 0, 0]}; {X1}. The second sub-range (X1-X4) contains the window W₁ with a corresponding alpha α₁ over the base plane 206. The transparency of the window W₁ in the (X1-X4) sub-range is stored in separate fields in the B₂ buffer range as {X1, [α₁, 0, 0]}; {X4}, where the {X4} field may be interpreted by the display controller 114 as {X4, [0, 0, 0]}. It is noted that the X1 coordinate indicates the location of the first window W₁ in the first display range M₂ that contains a window. Thus, the entry in the first range buffer 202 field indicates the beginning of the first window in any of the display ranges. This is because nothing is stored in the range buffer 202 fields for the background panel 206. The display controller (e.g., the display controller 114 shown in FIG. 1) reads the range buffer 202 fields: {X1, [α₁, 0, 0]}; {X4}. Accordingly, the display controller 114 applies the base plane alpha α₀ from the left edge 210 of the display 204 beginning in display range M₁ and X0 coordinate until the X1 coordinate is reached in display range M₁. Then from the X1 coordinate the display controller 114 applies the alpha triplet [α₁, 0, 0] until the X4 coordinate and then applies the base plane alpha α₀ from the X4 coordinate to the right edge 208 of the display 204 in the M₂ display range. The transparency of the window W₁ is defined only by α₁ with no contribution from α₂ or α₃, for example. As previously discussed, α₁ may take on values from 0 to 1. Therefore, for an alpha value α₁ equal to 1, the contribution to the image pixel is 100% and for a value of α₁ between 0 and 1, the contribution to the image pixel is the difference between the base plane 206 alpha α₀ and the window W₁ alpha α₁ because there is no contribution from the respective windows W₁, W₂ alphas α₂, α₂. The third sub-range (X4-X7) ending at the display edge 208 contains only the base plane alpha α₀ and nothing is stored in the range buffer 202 at the coordinate X7.

In the M₃ display range, the display 204 contains the windows W₁ and W₃ with respective alphas α₁ and α₃ over the base plane 206 and there may be a corresponding B₃ buffer range defined in the range buffer 202 memory. In the M₃ display range, the sub-ranges SR₁₋₅ are explicitly labeled for a better understanding of the embodiment. The first sub-range SR₁ (X0-X1) contains only the base plane alpha α₀ and there is no corresponding alpha triplet {[α₁, α₂, α₃]} stored in the range buffer 202. The second sub-range SR₂ (X1-X3) contains only the window W₁ with its corresponding α₁. The third sub-range SR₃ (X3-X4) contains a blend of the both the windows W₁ and W₃ with corresponding α₁ and α₃. The fourth sub-range SR₄ (X4-X5) contains only the window W3 with the corresponding α₃. And the fifth sub-range SR₅ (X5-X7) contains only the base plane alpha α₀ and nothing is stored in the range buffer 202. These may be defined in the range buffer 202 range B₃ as {X1, [α₁, 0, 0]}; {X3, [0, 0, α₃]}; {X5}. The display controller 114 reads the fields: {X1, [α₁, 0, 0]}; {X3, [0, 0, α₃]}; {X5}, and accordingly, applies the base plane alpha α₀ from the left edge 210 of the display 204 at the X0 coordinate until the X1 coordinate is reached. Then from the X1 coordinate the display controller 114 applies the alpha triplet [α₁, 0, 0] until the X3 coordinate is reached, then from the X3 coordinate applies the alpha triplet [0, 0, α₃] until the X5 coordinate is reached, then applies the base plane alpha α₀ to the right edge 208 of the display 204 at the coordinate X7.

In the M₄ display range, the display 204 contains only the window W₃ with the respective alpha α₃ over the base plane 206. A corresponding B₄ buffer range may be defined in the range buffer 202 memory. The sub-range (X0-X1) contains only the base plane alpha α₀ and there is no corresponding alpha triplet {[α₁, α₂, α₃]} stored in the range buffer 202. The sub-range (X4-X5) contains only the window W3 with its corresponding α₃. The sub-range (X5-X7) contains only the base plane alpha α₀ and there is no corresponding alpha triplet {[α₁, α₂, α₃]} stored in the range buffer 202. These may be defined in the B₄ buffer range as {X3, [0, 0, α₃]}; {X5}. The display controller 114 reads the fields: {X3, [0, 0, α₃]}; {X5}, and accordingly, applies the base plane alpha α₀ from the left edge 210 of the display 204 at the X0 coordinate until the X3 coordinate is reached. Then from the X3 coordinate the display controller 114 applies the alpha triplet [0, 0, α₃] until the X5 coordinate is reached, then applies the base plane alpha α₀ to the right edge 208 of the display 204 at the coordinate X7.

In the M₅ range, the display 204 contains the windows W₂ and W₃ with respective alphas α₂ and α₃ over the base plane 206. A corresponding B₅ buffer range may be defined in the range buffer 202 memory. The sub-range (X0-X2) contains only the base plane alpha α₀ and there is no corresponding alpha triplet {[α₁, α₂, α₃]} stored in the range buffer 202. The sub-range (X2-X3) contains only the window W₂ with its corresponding α₂. The third sub-range (X3-X5) contains a blend of the windows W₂ and W₃ based on the corresponding alphas α₂ and α₃. The sub-range (X5-X6) contains only the window W₂ with its corresponding alpha α₂. The sub-range (X6-X7) contains only the base plane alpha α₀ and there is no corresponding alpha triplet {[α₁, α₂, α₃]} stored in the range buffer 202. These may be defined in the B₅ buffer range as {X2, [0, α₂, 0]}; {X3, [0, α₂, α₃]}; {X5, [0, α₂, 0]}; {X6}. The display controller 114 reads the fields: {X2, [0, α₂, 0]}; {X3, [0, α₂, α₃]}; {X5, [0, α₂, 0]}; {X6}, and accordingly, applies the base plane alpha α₀ from the left edge 210 of the display 204 beginning at the X0 coordinate until the X2 coordinate is reached. Then from the X2 coordinate the display controller 114 applies the alpha triplet [0, α₂, 0] until the X3 coordinate is reached, then applies the alpha triplet [0, α₂, α₃] until the X5 coordinate is reached then applies the base plane alpha α₀ to the right edge 208 of the display 204 at the coordinate X7.

In the M₆ range, the display 204 contains the window W₂ with a corresponding alpha α₂ over the base plane 206. A corresponding B₆ buffer range may be defined in the range buffer 202 memory. The sub-range (X0-X2) contains only the base plane alpha α₀ and there is no corresponding alpha triplet {[α₁, α₂, α₃]} stored in the range buffer 202. The sub-range (X2-X6) contains only the window W₂ with its corresponding α₂. The sub-range (X6-X7) contains only the base plane alpha α₀ and there is no corresponding alpha triplet {[α₁, α₂, α₃]} stored in the range buffer 202. These may be defined in the B₆ buffer range as {X2, [0, α₂, 0]}; {X6}. The display controller 114 reads the fields: {X2, [0, α₂, 0]}; {X6}, and accordingly, applies the base plane alpha α₀ from the left edge 210 of the display 204 beginning at the X0 coordinate until the X2 coordinate is reached. Then from the X2 coordinate the display controller 114 applies the alpha triplet [0, α₂, 0] until the X6 coordinate is reached, then applies the base plane alpha α₀ to the right edge 208 of the display 204 at the coordinate X7.

The M₇ range does not contain any sub-ranges and for entire M₇ range R (X0-X7) of the display 204, the range buffer 202 does not store any alpha a values because there are no window overlays other than the background panel alpha defined by α₀. Accordingly, the previous X-coordinate X6 form the M₆ range is the ending X-coordinate stored in the range buffer 202 for the display 204.

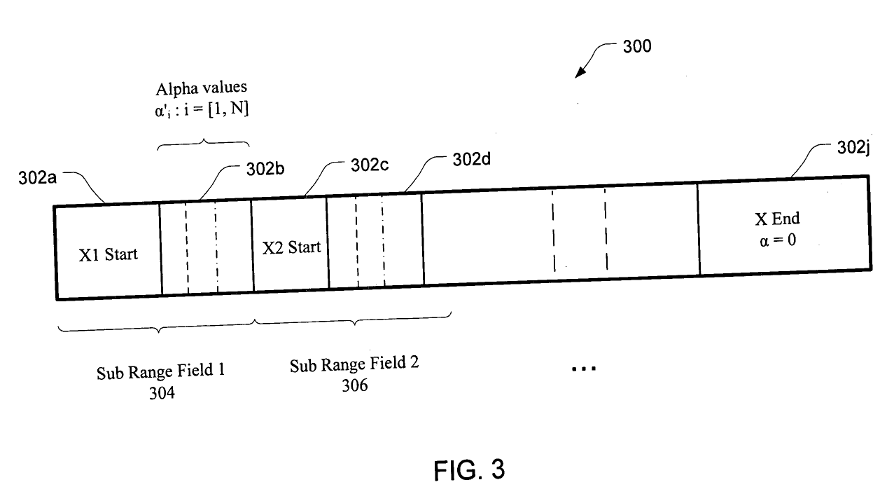

FIG. 3 illustrates a diagram of one embodiment of a field configuration for a range buffer 300. The range buffer 300 may be one implementation of the range buffer 202 shown in FIG. 2. The range buffer 300 comprises multiple fields 302a-j. The first field 302a stores the starting X-coordinate X1 for a display range (e.g., display ranges M₁₋ⱼ as shown in FIG. 2). The starting X-coordinate X1 corresponds to the first X-coordinate of the first window (e.g., W_{1-N} to be displayed on a display) in the first range M that comprises a window. Accordingly, the first field 302a comprises the X-coordinate X1 that indicates the beginning of the first sub-range field 304 (Field 1). The display controller 114 interprets the first field 302a in the range buffer 300 to mean that there are no windows to be displayed in any previous range(s) M. The second field 302b comprises the alpha values α_{1-N} for each of the windows W_{1-N} in the first sub-range 304. The third field 302c comprises the X-coordinate X2, which designates the beginning of the second sub-range field 306 (Field 2). The fourth field 302d comprises the alpha values α_{1-N} for each of the windows W_{1-N} in the second sub-range 306, and so forth. The last field 302j in the range buffer 300 comprises the X-coordinate X-end, which indicates the ending X-coordinate for the last sub-range. The display controller 114 interprets the content, e.g., X-end, in the last field 302j to mean that there are no more windows from the X-end coordinate to the edge of the display in the current and/or subsequent range(s) M. Thus, where alpha a stands for transparency, the display controller 114 assumes that α=0 for full transparency.

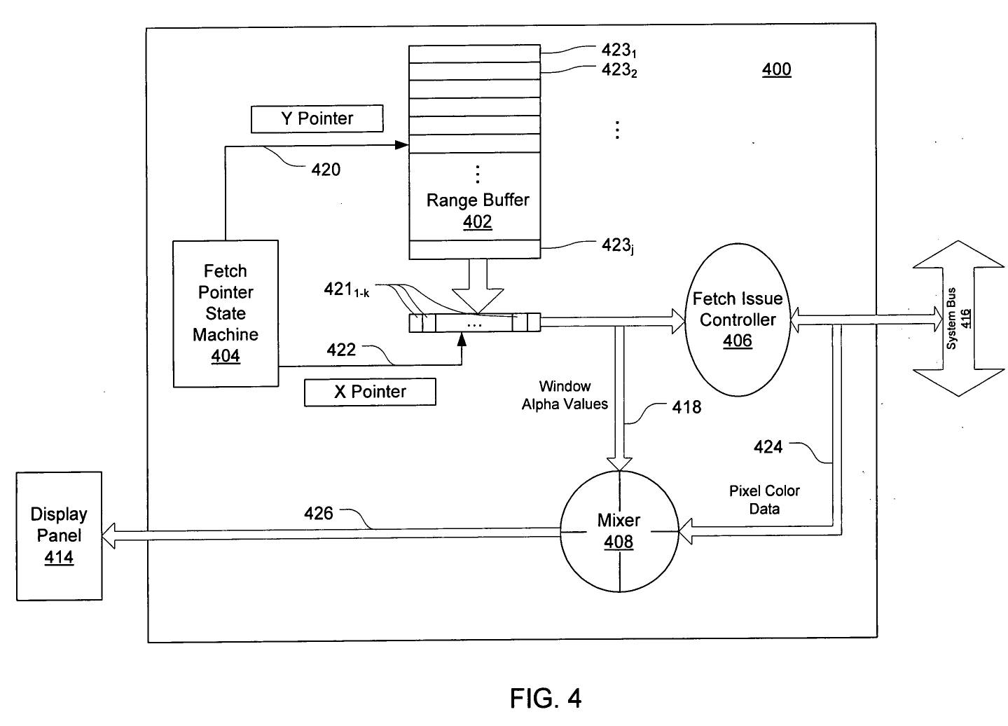

FIG. 4 illustrates a block diagram of one embodiment of a display controller 400. The display controller 400 may be representative of the display controller 114 shown in FIG. 1, for example. In one embodiment, the display controller 400 may be implemented as a processor. In one embodiment, the display controller 400 may be implemented as a system-on-a-chip. The display controller 400 may comprise a range buffer 402, a fetch pointer state machine 404, a fetch issue controller 406, and a mixer 408. The display controller 400 communicates via a system bus 416 (e.g., the system bus 116 shown in FIG. 1) and a display 414 (e.g., display 104 as shown in FIG. 1 and/or display 204 shown in FIG. 2). The range buffer 402 comprises multiple ranges 423₁₋ⱼ. The display controller 400 reads the range buffer 402 that has been programmed by software and fetches data from memory across the sub-ranges 421₁₋ₖ. If the window alpha a values 418 indicate occlusion across the sub-ranges 421₁₋ₖ, then only those windows that are unaffected by the occlusion are fetched.

In the embodiment illustrated in FIG. 4, the display controller 400 utilizes the range buffer 402, which may be implemented as a register file with a port width equal to the range 423i-j size. In other embodiments, e.g., in a system-on-a-chip environment, the range buffer 402 may be implemented as a pre-compiled memory to read-out sub-ranges. The display controller 400 may comprises a push dataflow structure with data valid signaling mechanisms that include the ability to signify null data. It will be appreciated buy those skilled in the art that a register file may comprise an array of processor registers in a central processing unit (CPU). Integrated circuit-based register files may be implemented by way of fast static random-access-memories (RAMs) with multiple ports. These RAMs may be distinguished by having dedicated read and write ports, whereas ordinary multi-ported static RAMs (SRAMs) usually read and write data through the same ports. The embodiments, however, are limited in this context.

In operation, the fetch pointer state machine 404 outputs a Y-pointer on line 420 and an X-pointer on line 422 to retrieve the window alpha a values 418 for each sub-range 421₁₋ₖ within the ranges 423₁₋ⱼ stored in the range buffer 402 corresponding to an output image comprising windows. The window alpha a values 418 are mixed or blended with the pixel color data 424 by the mixer 408. The pixel color data 424 are retrieved by the fetch issue controller 406 from memory via the system bus 416. The mixed/blended pixel color data 426 are then output to the display 414.

The display controller 400 provides increased performance through lower bandwidth requirements. Conventional usage models of display imagery have significant opacity amongst the various overlays that can be leveraged to reduce system bandwidth bottlenecks and reduce power accordingly. With increasing resolutions of the displays 104, 204, 414 and lower power consumption targets, the display controller 400 may provided certain advantages handheld and mobile devices such as the device 100 shown in FIG. 1.

As an illustration, a comparison in bandwidth requirements between the various embodiments of the display controller 114, 400 described herein and one existing architecture as implemented in the PXA27xx family of XScale® microarchitecture processors made by Intel® Corporation. The configuration chosen assumes one base plane (e.g., base plane 206) plus two overlays (e.g., windows W_{1, 2}) being displayed on a VGA screen (640×480) as the display 104, 204, 414, for example. The base plane covers the display and the percentage of overlap of the overlay layers is denoted by the occlusion ratio. Both overlays may be assumed to be of the same resolution, for example. The savings in bandwidth are tabulated in Table 1 below:

TABLE 1

| | |
|---|---|
| Overlay | |
| Resolution | Occlusion ratio |

| X | Y | 0% | 2% | 5% | 10% | 25% |
|---|---|---|---|---|---|---|
| 176 | 208 | 10% | 10% | 10% | 11% | 12% |
| 176 | 220 | 10% | 10% | 11% | 11% | 13% |
| 240 | 240 | 14% | 14% | 14% | 15% | 17% |
| 320 | 240 | 17% | 17% | 18% | 18% | 21% |
| 320 | 320 | 20% | 20% | 21% | 22% | 25% |
| 320 | 480 | 25% | 26% | 26% | 28% | 31% |
| 480 | 480 | 30% | 31% | 32% | 33% | 38% |
| 640 | 480 | 33% | 34% | 35% | 37% | 42% |

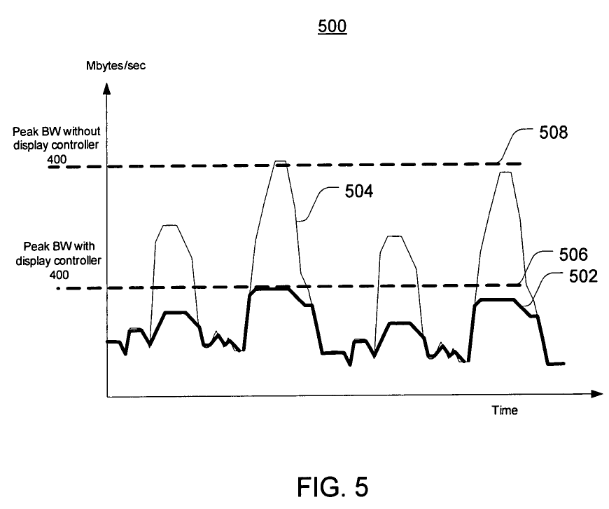

FIG. 5 illustrates a graph 500 that is representative of the peak bandwidth reduction that may be achieved utilizing the various embodiments of the display controller 114, 400 and range buffer described in FIGS. 1-4 herein. For example, the various embodiments of the display controller 114, 400 may reduce peak bandwidth (BW) requirements. The peak BW demand slows down access the memory by other components in the system (e.g., system-on-a-chip). The graph 500 shows Time (T) along the horizontal axis and peak BW in terms of access to memory rate in mega-bytes per second (Mbytes/sec) along the vertical axis. The graph 500 shows the relation between a first peak BW curve 502 (shown in dark line) and a second peak BW curve 504 (shown in faint line). The first peak BW curve 502 represents the peak BW 506 for a device that employs the display controller 114, 400 and logic described in accordance with various embodiments herein. The second peak BW curve 504 represents the peak BW 508 for a device that does not employ the display controller 114, 400 and logic as described in accordance with various embodiments herein.

Operations for the above described embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

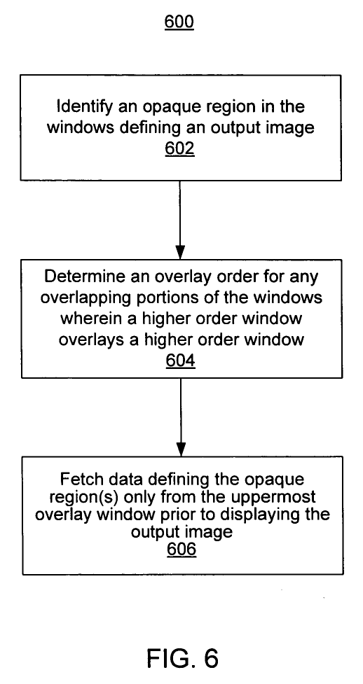

FIG. 6 illustrates one embodiment of a logic flow 600. The logic flow 600 may be representative of the operations executed by one or more embodiments described herein. The operations may be executed by the display controller 400 to identify (602) an opaque region 126a, b in the windows 124a-c defining the output image 122. The display controller 400 determines (604) an overlay order for any overlapping portions of the windows 124a-c, wherein a higher order window overlays a higher order window. For example, as shown in FIG. 1, the window 124b overlays the windows 124a, c. For example, as shown in FIG. 2, the window W₃ overlays the windows W₁ and W₂. The display controller 400 fetches (606) data defining the opaque region(s) 126a, b only from the uppermost overlay window prior to displaying the output image 122. In one embodiment, the display controller 400 may comprise the fetch pointer state machine 404 to implement the fetch. In the embodiment illustrated in FIG. 1, for example, the window 124b is the uppermost window relative to the windows 124a, c.

In various other embodiments, the display controller 400 may comprise logic to define multiple ranges M₁₋ⱼ of the output image 122. The multiple ranges M₁₋ⱼ define vertical portions of the windows W₁₋₃. The display controller 400 defines multiple sub-ranges (e.g., SR₁₋₅) within the multiple ranges M₁₋ⱼ, the multiple sub-ranges define horizontal portions of the windows W₁₋₃. The display controller 400 determines a transparency level (e.g., the alpha a values) for each of the windows W₁₋₃ in the multiple sub-ranges and retrieves only a single blended transparency level for any of the overlapping portions of the windows W_{1, 3} or W_{2, 3} in any one of the multiple sub-ranges. The sub-range (e.g., SR₁₋₅) may be identified within a range M₁₋ⱼ by a first starting X-value and the transparency level for all the windows W₁₋₃ in the sub-range. The sub-range defines the blended transparency level for the overlapping windows W_{1, 3} or W_{2, 3} in the sub-range. The end of any one of the sub-ranges may be identified by a single ending X-value, beyond which the sub-range does not contain a window. A range buffer 300 may be defined. The range buffer 300 comprises multiple sub-range fields 304, 306. The sub-range fields 304, 306 comprise first and second fields 302a, b (or 302c, d). The first field 302a or 302c is to store a starting X-value for a corresponding sub-range of the output display 122 and the second field 302b or 302d is to store the blended transparency level (e.g., the alpha α values) for each of the windows W₁₋₃ in the sub-range.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a display controller comprising logic to identify an opaque region in windows defining an output image; determine an overlay order for any overlapping portions of said windows, wherein a higher order window overlays a lower order window; fetch data defining said opaque region only from an uppermost overlay window prior to displaying said output image.

2. The apparatus of claim 1, wherein said display controller comprises logic to define multiple ranges of said output image, said multiple ranges defining vertical portions of said windows; define multiple sub-ranges within said multiple ranges, said multiple sub-ranges defining horizontal portions of said windows; determine a transparency level for each of said windows in said multiple sub-ranges; retrieve only a single blended transparency level for any of said overlapping portions of said windows in any one of said multiple sub-ranges.

3. The apparatus of claim 2, wherein said display controller comprises logic to identify a sub-range within a range by a first starting X-value and said transparency level for all windows within said sub-range, said sub-range defining said blended transparency level for said overlapping in said sub-range.

4. The apparatus of claim 3, wherein said display controller comprises logic to identify the end of any one of said sub-ranges by a single ending X-value, wherein beyond said ending X-value said sub-range does not contain a window.

5. The apparatus of claim 4, wherein said display controller comprises logic to define a range buffer comprising multiple sub-range fields, wherein said sub-range fields comprise first and second fields; wherein, said first field is to store a starting X-value for a corresponding sub-range of said display and said sub-range fields; and
wherein said second field is to store said blended transparency level for each of said windows in said sub-range.

6. A system, comprising:
a display; and
a display controller coupled to said display, said display controller comprising logic to identify an opaque region in windows defining an output image; determine an overlay order for any overlapping portions of said windows, wherein a higher order window overlays a lower order window; fetch data defining said opaque region only from an uppermost overlay window prior to displaying said output image.

7. The system of claim 6, wherein said display controller comprises a range buffer arranged to store multiple ranges and ranges defining an output image.

8. The system of claim 6, wherein said display controller comprises fetch pointer state machine to retrieve data from said range buffer.

9. The system of claim 6, wherein said display controller comprises a fetch issue controller coupled to said range buffer.

10. The system of claim 9, wherein said display controller comprises a mixer coupled to said fetch issue controller and said range buffer.

11. A method, comprising:
identifying an opaque region in windows defining an output image;
determining an overlay order for any overlapping portions of said windows, wherein a higher order window overlays a lower order window;
fetching data defining said opaque region only from an uppermost overlay window prior to displaying said output image.

12. The method of claim 11, comprising:
defining multiple ranges of said output image, said multiple ranges defining vertical portions of said windows;
defining multiple sub-ranges within said multiple ranges, said multiple sub-ranges defining horizontal portions of said windows;
determining a transparency level for each of said windows in said multiple sub-ranges;
retrieving only a single blended transparency level for any of said overlapping portions of said windows in any one of said multiple sub-ranges.

13. The method of claim 12, comprising:
identifying a sub-range within a range by a first starting X-value and said transparency level for all windows within said sub-range, said sub-range defining said blended transparency level for said overlapping in said sub-range.

14. The method of claim 13, comprising:
identifying the end of any one of said sub-ranges by a single ending X-value, wherein beyond said ending X-value said sub-range does not contain a window.

15. The method of claim 14, comprising:
defining a range buffer comprising multiple sub-range fields, wherein said sub-range fields comprise first and second fields;
wherein, said first field is to store a starting X-value for a corresponding sub-range of said display and said sub-range fields; and
wherein said second field is to store said blended transparency level for each of said windows in said sub-range.

16. An article comprising a machine-readable storage medium containing instructions that if executed enable a system to identify an opaque region in windows defining an output image; determine an overlay order for any overlapping portions of said windows, wherein a higher order window overlays a lower order window; fetch data defining said opaque region only from an uppermost overlay window prior to displaying said output image.

17. The article of claim 16, further comprising instructions that if executed enable the system to define multiple ranges of said output image, said multiple ranges defining vertical portions of said windows; define multiple sub-ranges within said multiple ranges, said multiple sub-ranges defining horizontal portions of said windows; determine a transparency level for each of said windows in said multiple sub-ranges; retrieve only a single blended transparency level for any of said overlapping portions of said windows in any one of said multiple sub-ranges.

18. The article of claim 17, further comprising instructions that if executed enable the system to identify a sub-range within a range by a first starting X-value and said transparency level for all windows within said sub-range, said sub-range defining said blended transparency level for said overlapping in said-range.

19. The article of claim 18, further comprising instructions that if executed enable the system to identify the end of any one of said sub-ranges by a single ending X-value, wherein beyond said ending X-value said sub-range does not contain a window.

20. The article of claim 19, further comprising instructions that if executed enable the system to define a range buffer comprising multiple sub-range fields, wherein said sub-range fields comprise first and second fields; wherein, said first field is to store a starting X-value for a corresponding sub-range of said display and said sub-range fields; and wherein said second field is to store said blended transparency level for each of said windows in said sub-range.
